(19) United States
(12) Patent Application Publication
(10) Pub. No.: US 2026/0167205 A1
(43) Pub. Date: Jun. 18, 2026

(54) VEHICLE CONTROL SYSTEM

(71) Applicant: SUBARU CORPORATION, Tokyo (JP)

(72) Inventors: Hirofumi YABE, Tokyo (JP); Atsushi DOKI, Tokyo (JP)

(21) Appl. No.: 18/711,009

(22) PCT Filed: Dec. 8, 2022
(86) PCT No.: PCT/JP2022/045294

§ 371 Date: May 16, 2024

(51) Int. Cl. B60W 50/00

(52) U.S. Cl. CPC B60W 50/0098; B60W 2050/0082; B60W 2050/0085

(57) ABSTRACT

One or more first processors are configured to execute a process including: performing generation of instruction information indicating a control value for the control target; performing a reset process of resetting the control value for the control target to an initial value when a specific condition is satisfied in a calculation state in which various calculations including the generation of the instruction information are executable; returning to the calculation state after the reset process; generating a reliability flag indicating reliability of the instruction information; and transmitting the generated instruction information and the generated reliability flag to the second control unit. One or more second processors are configured to execute a process including executing control of the control target, based on the received instruction information and the received reliability flag.

### TECHNICAL FIELD

The invention relates to a vehicle control system.

### BACKGROUND ART

For example, Patent Literature 1 discloses a vehicle in which an electronic control unit (ECU), a battery control unit (BCU), and a motor control unit (MCU) are communicable with each other through a CAN. In Patent Literature 1, an adhesion determination process for a contactor and a malfunction diagnosis process for a voltage sensor are performed.

### CITATION LIST

### Patent Literature

Patent Literature 1: Japanese Unexamined Patent Application Publication No. 2020-145877

### SUMMARY OF INVENTION

### Problem to be Solved by the Invention

For example, it is possible for a high-order control unit such as an ECU to control a control target such as a system main relay corresponding to a low-order control unit such as a BCU through the low-order control unit. Here, the high-order control unit sometimes performs a reset process of resetting a control value for the control target to an initial value when a specific condition is satisfied. For example, when an ignition switch is in an ON state, the ignition switch is sometimes temporarily brought into an OFF state and into the ON state again in a short period of time. In such a case, the above-described reset process may be performed. In this example, when the reset process is performed, the system main relay is temporarily brought into the OFF state from the ON state and brought into the ON state again in a short period of time due to the ignition switch being brought into the ON state again. This may possibly cause damage to or an abnormality in devices mounted on a vehicle, such as adhesion of a contact in the system main relay. Note that, although the system main relay is given as an example, an abnormality is not limited to occur in the system main relay, and various abnormalities may possibly occur depending on the control target.

Accordingly, it is an object of the invention to provide a vehicle control system that makes it possible to reduce occurrence of an abnormality in a vehicle even when a reset process is performed in a control unit.

### Means for Solving the Problem

To solve the above-described problem, an aspect of the invention provides a vehicle control system that includes:
a first control unit including one or more first processors and one or more first memories coupled to the one or more first processors;
a second control unit including one or more second processors and one or more second memories coupled to the one or more second processors, the second control unit being configured to communicate with the first control unit; and
a control target associated with the second control unit.

The one or more first processors are configured to execute a process including:
performing generation of instruction information indicating a control value for the control target;
performing a reset process of resetting the control value for the control target to an initial value when a specific condition is satisfied in a calculation state in which various calculations including the generation of the instruction information are executable;
returning to the calculation state after the reset process;
generating a reliability flag indicating reliability of the instruction information; and
transmitting the generated instruction information and the generated reliability flag to the second control unit.

The one or more second processors are configured to execute a process including executing control of the control target, based on the received instruction information and the received reliability flag.

### Effects of the Invention

According to the invention, it is possible to reduce the occurrence of the abnormality in the vehicle even when the reset process is performed in the control unit.

### BRIEF DESCRIPTION OF DRAWINGS

FIG. 1 is a schematic diagram illustrating a configuration of a vehicle control system according to a present embodiment.

FIG. 2 is a diagram for describing sleeping and waking up of a high-order control unit.

FIG. 3 is a time chart of a comparative example for describing an issue caused by re-ignition in a short period of time.

FIG. 4 is a time chart for describing a state of a reliability flag according to the present embodiment.

FIG. 5 is a diagram for describing states of instruction information, the reliability flag, and a low-order control unit during a transmission stop period, an unreliable period, and a reliable period.

FIG. 6 is a time chart for describing an example of a case where actual state information is acquired in an initialization state.

FIG. 7 is a time chart for describing an example of a case where it is determined that a predetermined exclusion condition is satisfied.

FIG. 8 is a flowchart for describing a flow of operation related to a reset process in a high-order controller.

FIG. 9 is a flowchart for describing a flow of initialization.

FIG. 10 is a flowchart for describing a flow of operation of the high-order controller after completion of the initialization.

FIG. 11 is a flowchart for describing an outline of a flow of operation of a low-order controller.

FIG. 12 is a flowchart for describing a first specific example of the operation of the low-order controller.

FIG. 13 is a flowchart for describing a second specific example of the operation of the low-order controller.

FIG. 14 is a flowchart for describing a third specific example of the operation of the low-order controller.

FIG. 15 is a flowchart for describing a fourth specific example of the operation of the low-order controller.

### MODES FOR CARRYING OUT THE INVENTION

In the following, embodiments of the invention will be described in detail with reference to the accompanying drawings. Factors including, without limitation, specific dimensions, material, and numerical values indicated in the embodiments are illustrative only to facilitate understanding of the invention and not to be construed as limiting to the invention unless otherwise specified. Note that, throughout the specification and the drawings, elements having substantially the same function and configuration are denoted with the same reference numerals to avoid any redundant description. Further, illustration of elements that are not directly related to the invention is omitted.

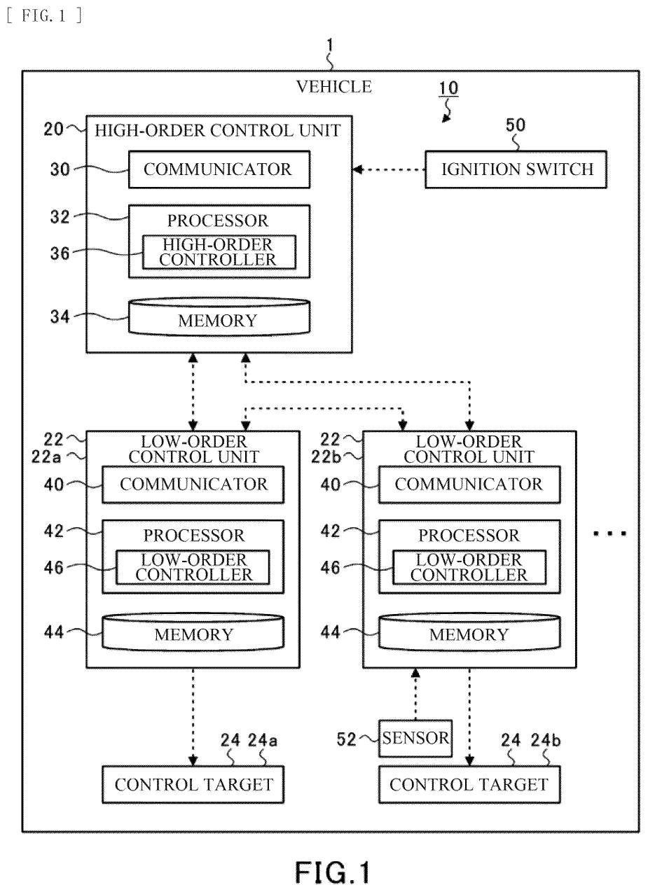

FIG. 1 is a schematic diagram illustrating a configuration of a control system 10 for a vehicle 1 according to the present embodiment. The vehicle 1 is, for example, a hybrid electric vehicle including an engine and a motor as drive sources for traveling. Note that the vehicle 1 is not limited to the hybrid electric vehicle and may be an electric vehicle or an engine vehicle. Hereinafter, the vehicle 1 may be referred to as an own vehicle. The control system 10 is a system that is applied to the vehicle 1 and controls devices that configure the vehicle 1.

The control system 10 includes a high-order control unit 20, a low-order control unit 22, and a control target 24. Hereinafter, the control unit may be referred to as a CU. The high-order control unit 20 is an example of a first control unit of the invention. The low-order control unit 22 is an example of a second control unit of the invention.

The high-order control unit 20 is, for example, a hybrid electric vehicle control unit (HEVCU). That is, the high-order control unit 20 is an integrated control unit that performs overall control of the entire vehicle 1.

In an example of FIG. 1, a low-order control unit 22a and a low-order control unit 22b are illustrated as multiple low-order control units 22. However, the number of the low-order control units 22 is not limited to two, and may be one or three or more.

The high-order control unit 20 is communicable with each of the low-order control units 22. The low-order control units 22 are communicable with each other. Further, each of the low-order control units 22 is associated with the control target 24. Each of the low-order control units 22 is configured to execute control of the corresponding control target 24.

In the example of FIG. 1, a control target 24a and a control target 24b are illustrated as multiple control targets 24. However, the number of the control targets 24 is not limited to two, and may be one or three or more. Further, the number of the control targets 24 corresponding to one low-order control unit 22 is not limited to one, and may be more than one. The control target 24 corresponding to the low-order control unit 22 is different for each low-order control unit 22.

The low-order control unit 22a is, for example, a battery control unit (BCU). The control target 24a corresponding to the low-order control unit 22a is, for example, a system main relay. The system main relay is a contactor that is able to electrically open and close a circuit between a high-voltage system wiring line and a high-voltage battery of the vehicle 1. Hereinafter, the system main relay may be simply referred to as a relay. Note that the low-order control unit 22a is not limited to the battery control unit. Further, the control target 24a is not limited to the system main relay.

The low-order control unit 22b is, for example, a motor control unit (MCU). The control target 24b corresponding to the low-order control unit 22b is, for example, a traveling motor and an inverter that drives the motor. Note that the low-order control unit 22b is not limited to the motor control unit. Further, the control target 24b is not limited to the motor and the inverter.

The high-order control unit 20 includes a communicator 30, one or more processors 32, and one or more memories 34 coupled to the processor(s) 32. The processor 32 is an example of a first processor of the invention. The memory 34 is an example of a first memory of the invention.

The communicator 30 configures a controller area network (CAN) with each of the low-order control units 22. This makes it possible to establish communication with each of the low-order control units 22.

The memory 34 includes a ROM in which, for example, a program is stored, and a RAM as a work area. Further, the memory 34 may include, without limitation, a register and an electrically rewritable semiconductor storage element. The processor 32 cooperates with the program included in the memory 34 to implement operation of the high-order control unit 20. The processor 32 also functions as a high-order controller 36 by executing the program.

The high-order controller 36 is configured to control each of the control targets 24 through the corresponding low-order control unit 22. For example, the high-order controller 36 is able to execute various calculations including generation of instruction information indicating a control value for the control target 24. The high-order controller 36 transmits the generated instruction information to the low-order control unit 22 through the communicator 30. The low-order control unit 22 normally executes the control of the control target 24 in accordance with the instruction information received from the high-order control unit 20. The high-order controller 36 will be described in detail later.

Each of the low-order control units 22 includes a communicator 40, one or more processors 42, and one or more memories 44 coupled to the processor(s) 42. The processor 42 is an example of a second processor of the invention. The memory 44 is an example of a second memory of the invention.

The communicator 40 configures a controller area network (CAN) with the high-order control unit 20 and each of the low-order control units 22. This makes it possible to establish communication with the high-order control unit 20 and each of the low-order control units 22.

The memory 44 includes a ROM in which, for example, a program is stored, and a RAM as a work area. Further, the memory 44 may include, without limitation, a register and an electrically rewritable semiconductor storage element. The processor 42 cooperates with the program included in the memory 44 to implement operation of the low-order control unit 22. The processor 42 also functions as a low-order controller 46 by executing the program.

The low-order controller 46 is configured to receive the instruction information transmitted from the high-order control unit 20. The low-order controller 46 normally executes the control of the control target 24 in accordance with the received instruction information. The low-order controller 46 will be described in detail later.

The control system 10 further includes an ignition switch 50. The ignition switch 50 is operated by an occupant of the vehicle 1 to start and stop the vehicle 1. It is possible for the high-order control unit 20 to acquire information indicating a state of the ignition switch 50. When the ignition switch 50 is brought into an ON state, the high-order control unit 20 brings the vehicle 1 into an ignition on (IG-ON) state in which the vehicle 1 is able to travel. When the ignition switch 50 is brought into an OFF state, the high-order control unit 20 brings the vehicle 1 into an ignition off (IG-OFF) state in which the vehicle 1 is unable to travel.

The control system 10 may further include various sensors 52 that detect, for example, an operation state and an environmental state of the control target 24. It is possible for the low-order control unit 22 to acquire detection values of the operation state and the environmental state of the control target 24 from the sensors 52. For example, one of the sensors 52 corresponding to the control target 24b may be a rotation speed sensor that detects a rotation speed of the motor that is an example of the control target 24b. In this example, it is possible for the low-order control unit 22b to recognize an actual value of the rotation speed of the motor that is an example of the control target 24b by acquiring a detection value of the rotation speed sensor that is an example of the sensor 52.

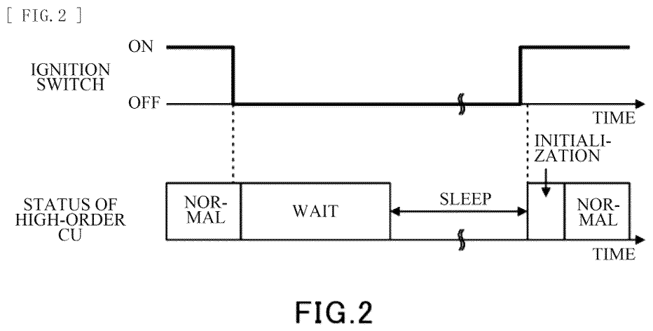

FIG. 2 is a diagram for describing sleeping and waking up of the high-order control unit 20. As illustrated in FIG. 2, the high-order control unit 20 wakes up or is put into sleep in response to switching on or off the ignition switch 50.

More specifically, when the ignition switch 50 is in the ON state, a status of the high-order control unit 20 is in a normal state in which a normal calculation is executed. Here, assume that the ignition switch 50 is switched from the ON state to the OFF state by the occupant of the vehicle 1. Upon receiving the information indicating the state of the ignition switch 50 and recognizing that the ignition switch 50 is switched from the ON state to the OFF state, the high-order controller 36 sets the status of the high-order control unit 20 to a wait state. In the wait state, for example, a diagnosis of each device of the vehicle 1 is executed. When, for example, the diagnosis of each device is completed and the vehicle 1 is in a state that the vehicle 1 may be brought into a state of being unable to travel, the high-order controller 36 transmits, to the low-order control unit 22, the instruction information that brings the system main relay to an OFF state. Thereafter, the high-order control unit 20 shifts from the wait state to a sleep state. Further, the low-order control unit 22 that has received the instruction information that brings the system main relay into the OFF state puts the system main relay into the OFF state.

Further, assume that, in the sleep state, the ignition switch 50 is switched from the OFF state to the ON state by the occupant of the vehicle 1. Upon receiving the information indicating the state of the ignition switch 50 and recognizing that the ignition switch 50 has switched from the OFF state to the ON state, the high-order controller 36 wakes up the high-order control unit 20 in the sleep state. After waking up, the high-order control unit 20 enters an initialization state in which initialization is executed. The initialization is a process including various initial settings that enable the vehicle 1 to travel. When the initialization is completed, the status of the high-order control unit 20 shifts from the initialization state to the normal state. When the status of the high-order control unit 20 is in the normal state, the vehicle 1 is able to travel.

Incidentally, in some cases, the ignition switch 50 is switched from the OFF state to the ON state within a short period of time after the ignition switch 50 is switched from the ON state to the OFF state by the occupant of the vehicle 1. When such re-ignition in a short period of time is performed, a following issue occurs. In particular, when such re-ignition in a short period of time is performed while the vehicle 1 is traveling, the following issue appears markedly.

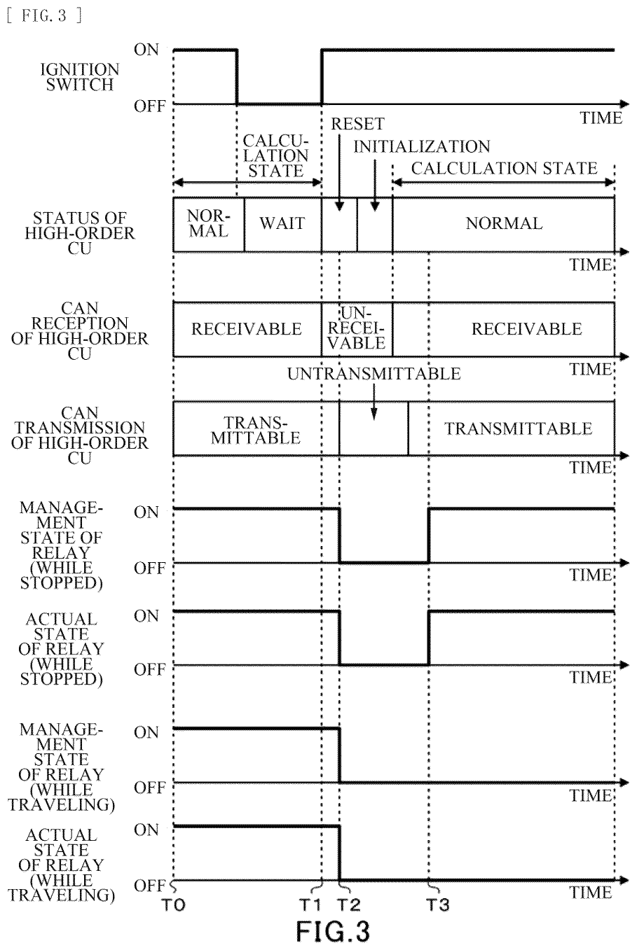

FIG. 3 is a time chart of a comparative example for describing the issue caused by the re-ignition in a short period of time. When the status of the high-order control unit 20 is in the normal state or the wait state, it is possible to perform various calculations. Accordingly, the normal state and the wait state may be collectively referred to as a calculation state in which it is possible to perform various calculations.

When the re-ignition in a short period of time is performed, the ignition may be switched on before the wait state of the high-order control unit 20 ends. This causes the high-order control unit 20 to remain in a running state without sleeping.

In such a case, the high-order control unit 20 shifts from the wait state to a reset state in response to switching on of the ignition during the wait state. In the reset state, a reset process of resetting control values of the various control targets 24 to initial values is performed. After the completion of the reset process in the reset state, the status of the high-order control unit 20 shifts to the initialization state and shifts to the normal state after the initialization state.

In this manner, when a specific condition is satisfied in the calculation state in which it is possible to perform calculations, the high-order controller 36 performs the reset process of resetting the control value for the control target 24 to the initial value. An example of the specific condition is a condition in which the ignition switch 50 is switched from the OFF state to the ON state before the calculation state is shifted to the sleep state, that is, during the calculation state. Further, after the reset process, the high-order controller 36 goes through the initialization and returns to the calculation state.

Note that the initial value set by the reset process and the values of various initial settings in the initialization are not necessarily the same value, and may be different values.

When the status of the high-order control unit 20 is the normal state or the wait state, the high-order control unit 20 is able to receive various kinds of information through the CAN by the communicator 30. In contrast, when the status of the high-order control unit 20 is in the reset state or the initialization state, the high-order control unit 20 is in a state of being unable to receive various kinds of information through the CAN. This makes it possible to prevent the communication through the CAN from becoming unstable and to appropriately perform the reset process and the initialization.

Further, when the status of the high-order control unit 20 is in the normal state or the wait state, the high-order control unit 20 is basically able to transmit various kinds of information through the CAN by the communicator 30. Note that, however, in a first calculation after the initialization state is shifted to the normal state, the high-order control unit 20 is in a state of being unable to transmit the information until generation of the information to be transmitted is completed. When the status of the high-order control unit 20 is in the reset state, the high-order control unit 20 is able to transmit various kinds of information through the CAN until the initial value set by the reset process is transmitted to the low-order control unit 22. After transmission of the initial value is completed, the high-order control unit 20 is in a state of being unable to transmit various kinds of information through the CAN. When the status of the high-order control unit 20 is in the initialization state, the high-order control unit 20 is basically in a state of being unable to transmit various kinds of information through the CAN. This makes it possible to prevent the communication through the CAN from becoming unstable and to appropriately perform the reset process and the initialization.

In the following, a comparative example of the control of the system main relay that is an example of the control target 24a will be used to describe the issue in detail. Here, a control state of the system main relay is managed in the high-order control unit 20. Hereinafter, for convenience of description, the control state of the system main relay managed in the high-order control unit 20 may be referred to as a management state of the relay. Further, for convenience of description, an actual operation state of the system main relay as a result of the control may be referred to as an actual state of the relay.

For example, assume that, at a point in time T0 when the status of the high-order control unit 20 is in the normal state, both the management state of the relay and the actual state of the relay are in the ON state. Assume that, thereafter, the status of the high-order control unit 20 is switched to the wait state. During the wait state, the management state of the relay and the actual state of the relay are maintained in the ON state.

First, a case where the vehicle 1 is stopped will be described. As indicated at a point in time T1, when the wait state is switched to the reset state, the reset process is started. Accordingly, at a point in time T2 during the reset state, the control value for the system main relay that is the control target 24 is reset to the initial value, whereby the management state of the relay is switched to the OFF state, which is the initial value. Thereafter, the management state of the relay is maintained in the OFF state. Immediately after switching from the initialization state to the normal state, the management state of the relay is in the OFF state, which is the initial value. However, as indicated at a point in time T3, when the calculation in the normal state proceeds, the management state of the relay is switched from the OFF state to the ON state, based on the ignition switch being in the ON state.

As described above, at the point in time T2, the management state of the relay is reset to the OFF state, which is the initial value, causing the instruction information, in which the initial value is set as the control value, to be transmitted to the low-order control unit 22. At the point in time T2, the low-order control unit 22 that has received the instruction information controls the system main relay to be brought into the OFF state, which is the initial value. This causes the actual state of the relay to be switched from the ON state to the OFF state. Further, as described above, at the point in time T3, the management state of the relay is switched to the ON state, causing the instruction information, in which the ON state is set, to be transmitted to the low-order control unit 22. At the point in time T3, the low-order control unit 22 that has received the instruction information controls the system main relay to be brought into the ON state. This causes the actual state of the relay to be switched from the OFF state to the ON state.

In this manner, in the high-order control unit 20, the reset process and the return from the reset state to the calculation state are performed. This causes the system main relay to be temporarily brought into the OFF state and, in a short period of time, into the ON state again. In this case, when the system main relay is in the OFF state, a voltage difference and a current difference may occur across the system main relay. If the system main relay is brought into the ON state in a state where such a voltage difference and a current difference have occurred, the system main relay may possibly be damaged due to, for example, occurrence of adhesion of a contact in the system main relay. Further, an abnormality is not limited to the damage to the system main relay, and may possibly occur in the operation of each device electrically coupled to the system main relay, for example.

Further, the re-ignition in a short period of time is performed not only when the vehicle 1 is stopped, and may be performed while the vehicle 1 is traveling. Assume that the management state of the relay and the actual state of the relay are brought into the OFF state while the vehicle 1 is traveling, for example, at the point in time T2. Thereafter, assume that, at the point in time T3, it is recognized that the ignition switch 50 is in the ON state. However, because the vehicle 1 is traveling at the point in time T3, for example, erroneous detection such as erroneous detection of an adhesion abnormality in the system main relay or erroneous detection of an overvoltage of the motor may possibly occur. When such erroneous detection occurs, it is not permitted to return the system main relay to the ON state even if it is desired, and the management state of the relay is maintained in the OFF state. Thus, the actual state of the relay is also maintained in the OFF state. In such a situation, it is difficult to cause the system main relay to return from the OFF state to the ON state, making it difficult to allow the vehicle 1 to continue traveling.

Note that, in FIG. 3, a description has been given of an example in which the control target 24 is the system main relay, but the control target 24 is not limited to the system main relay, and a substantially similar issue may possibly occur even when the control target 24 is any device configuring the vehicle 1. For example, in a case where the control target 24 is a motor and an inverter, electric power supply to the motor may be temporarily interrupted by performing the reset process in the high-order control unit 20. This may possibly fluctuate a torque of the motor temporarily, causing operability and comfort of the vehicle 1 to be impaired.

Accordingly, in the control system 10 of the present embodiment, the high-order controller 36 generates not only the instruction information indicating the control value for the control target 24 but also a reliability flag indicating the reliability of the instruction information. In a state in which the instruction information is reliable, the reliability flag is set to an ON state. In a state in which the instruction information is unreliable, the reliability flag is set to an OFF state. The high-order controller 36 transmits the generated instruction information and the generated reliability flag to the low-order control unit 22.

In the control system 10 of the present embodiment, it is possible for the low-order controller 46 to receive not only the instruction information but also the reliability flag. The low-order controller 46 executes the control of the control target 24, based on the received instruction information and the received reliability flag.

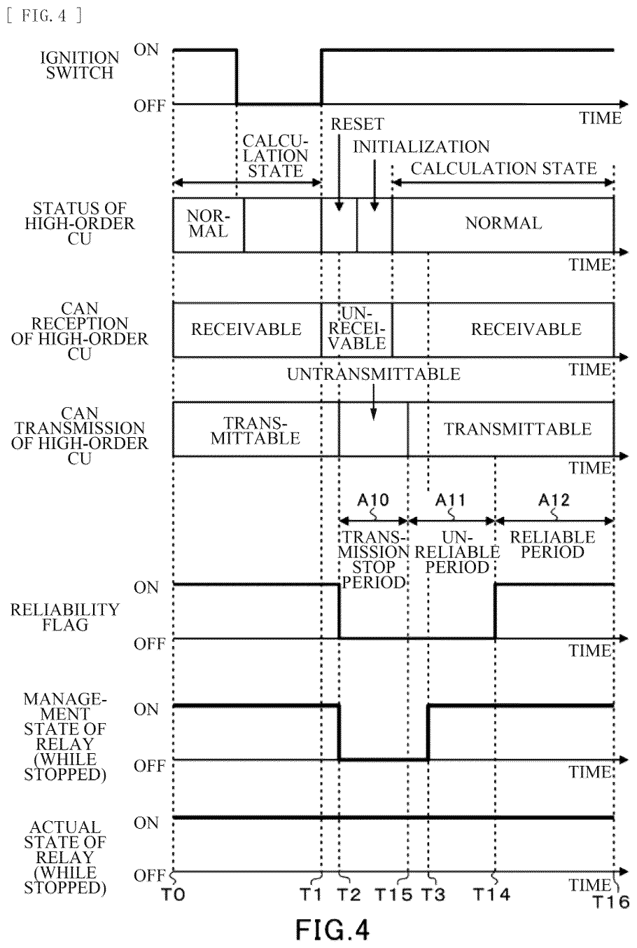

FIG. 4 is a time chart for describing a state of the reliability flag according to the present embodiment. In FIG. 4, the items including the ignition switch 50, the status of the high-order control unit 20, a CAN reception of the high-order control unit 20, and a CAN transmission of the high-order control unit 20 are the same as those in FIG. 3.

Because it is possible to generate reliable instruction information from the point in time T0 to the point in time T1 in FIG. 4, the reliability flag is in the ON state. As indicated at the point in time T1 in FIG. 4, the status of the high-order control unit 20 shifts to the reset state. As indicated at the point in time T2, when the control value for the system main relay is reset to the initial value by the reset process, the management state of the relay is brought into the OFF state. Additionally, the reliability flag is brought into the OFF state in accordance with the reset process. Thereafter, the reliability flag is maintained in the OFF state until it is switched to the ON state.

When the status shifts from the initialization state to the normal state, and the calculation proceeds, the management state of the relay is switched from the OFF state to the ON state, based on the ignition switch 50 being in the ON state, as indicated at the point in time T3 in FIG. 4. The high-order controller 36 generates the instruction information of the system main relay, based on the management state of the relay.

However, at the point in time T2 in FIG. 4, a predetermined reliability condition given below is not satisfied. Accordingly, at the point in time T2 in FIG. 4, it is possible to estimate that the instruction information based on the management information of the relay is unreliable, and the reliability flag is maintained in the OFF state indicating that the instruction information is unreliable.

The predetermined reliability condition includes, for example, a condition indicating that the vehicle 1 is estimated not to be traveling. For example, the predetermined reliability condition may be that a rotation speed of the traveling motor is substantially zero. Alternatively, the predetermined reliability condition may be that a speed of the vehicle 1 is substantially zero, or an accelerator position is substantially zero.

The high-order controller 36 maintains the reliability flag in the OFF state indicating that the instruction information is unreliable while the predetermined reliability condition is not satisfied. In contrast, when the predetermined reliability condition is satisfied, the high-order controller 36 brings the reliability flag to the ON state indicating that the instruction information is reliable. In the example of FIG. 4, at a point in time T14, the predetermined reliability condition is satisfied, and the reliability flag is switched from the OFF state to the ON state.

Here, as indicated by a double-headed arrow A10 in FIG. 4, a period from the point in time T2 to a point in time T15, that is, a period in which the high-order control unit 20 is unable to perform transmission through the CAN may be referred to as a transmission stop period. Further, as indicated by a double-headed arrow A11 in FIG. 4, a period from the point in time T15 to the point in time T14, that is, a period in which the high-order control unit 20 is able to communicate through the CAN and it is determined that the instruction information is unreliable may be referred to as an unreliable period. Further, as indicated by a double-headed arrow A12 in FIG. 4, a period from the point in time T14 to a point in time T16, that is, a period in which the high-order control unit 20 is able to communicate through the CAN and it is determined that the instruction information is reliable may be referred to as a reliable period.

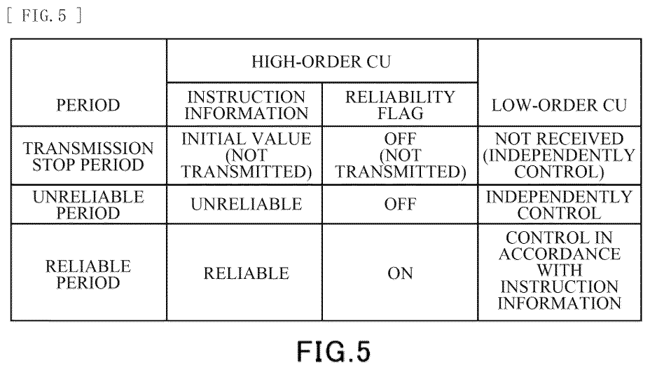

FIG. 5 is a diagram for describing states of the instruction information, the reliability flag, and the low-order control unit 22 during the transmission stop period, the unreliable period, and period.

Because transmission through the CAN is not possible in the transmission stop period, the instruction information that is set to the initial value is not transmitted to the low-order control unit 22. In the transmission stop period, although the reliability flag is brought into the OFF state by the reset process, the reliability flag is not transmitted to the low-order control unit because the transmission through the CAN is not possible. Because the transmission through the CAN is not possible in the transmission stop period, the low-order control unit 22 does not receive the instruction information or the reliability flag. Note that, however, immediately before the transmission stop period, the low-order control unit 22 has received the reliability flag in the OFF state indicating that the instruction information is unreliable, in accordance with the reset process. Thus, in the transmission stop period, the low-order control unit 22 independently controls the control target 24 because the reliability flag is in the OFF state.

In the unreliable period, the high-order controller 36 generates the instruction information. However, it is estimated that the instruction information is unreliable. In the unreliable period, the high-order controller 36 sets the reliability flag to the OFF state. In the unreliable period, the low-order control unit 22 will receive unreliable instruction information and the reliability flag in the OFF state. Because the reliability flag is in the OFF state, the low-order controller 46 independently controls the control target 24 regardless of the received instruction information. That is, in the unreliable period, the low-order controller 46 serves as a control source and controls the control target 24.

In the reliable period, the high-order controller 36 generates the instruction information estimated to be reliable. In the reliable period, the high-order controller 36 sets the reliability flag to the ON state. In the reliable period, the low-order control unit 22 will receive the reliable instruction information and the reliability flag in the ON state. Because the reliability flag is in the ON state, the low-order controller 46 executes the control of the control target 24 in accordance with the received instruction information.

A description will be given returning to FIG. 4. At the point in time T2, the low-order control unit 22 receives the instruction information in which the initial value is set as the control value and the reliability flag in the OFF state indicating that the instruction information is unreliable. Because the reliability flag is in the OFF state, the low-order controller 46 independently controls the control target 24. For example, the low-order controller 46 independently controls the state of the control target 24 to be maintained in an immediately preceding state. Thus, the actual state of the relay is maintained in the ON state during the transmission stop period from the point in time T2 onward.

In the unreliable period from the point in time T15 to the point in time T14, the low-order controller 46 independently controls the control target 24 as described above. For example, the low-order controller 46 independently controls the state of the control target 24 to be maintained in the immediately preceding state. Thus, the actual state of the relay in the unreliable period is maintained in the ON state.

In the reliable period from the point in time T14 to the point in time T16, the low-order controller 46 controls the control target in accordance with the received instruction information as described above. For example, because the management state of the relay in the reliable period is in the ON state, the low-order control unit 22 receives the instruction information indicating the ON state. The low-order controller 46 controls the system main relay in accordance with the received instruction information in the ON state. Thus, the actual state of the relay in the reliable period is maintained in the ON state.

In this manner, in the control system 10 of the present embodiment, even when the specific condition is satisfied and the reset process is performed in the high-order control unit 20, the low-order control unit 22 executes the control of the control target 24, based on the instruction information and the reliability flag. This makes it possible for the control system 10 of the present embodiment to appropriately control the control target 24 even when the reset process is performed. For example, as illustrated in FIG. 4, it is possible for the control system 10 of the present embodiment to maintain the actual state of the relay in the ON state from immediately before the reset process until the reliable instruction information is generated after going through the reset process. As a result, it is possible to reduce abnormalities in the devices such as damage to the system main relay.

In FIG. 4, the management state of the relay is switched from the OFF state to the ON state when it is recognized that the ignition is switched on as indicated at the point in time T3 when the management state of the relay is in the OFF state and the high-order control unit 20 is in the normal state. However, the high-order control unit 20 may acquire, in the initialization state, actual state information indicating an actual state of the control target 24, for example, information indicating the actual state of the relay. When the acquired actual state information does not indicate the initial value of the control value for the control target 24, the high-order control unit 20 may set a value of the actual state information as the control value for the control target 24.

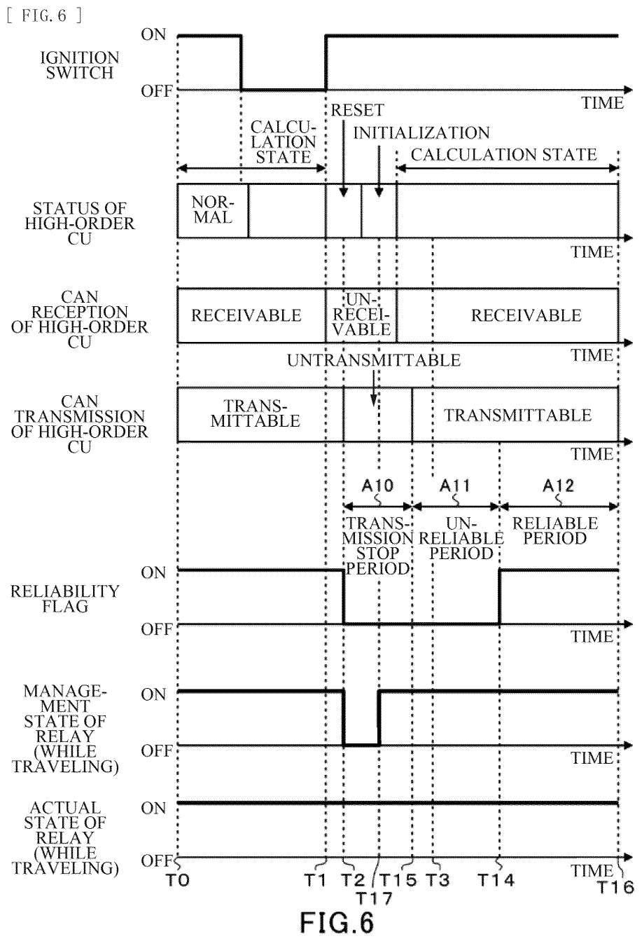

FIG. 6 is a time chart for describing an example of a case where the actual state information is acquired in the initialization state. FIG. 6 is an example in which the re-ignition in a short period of time is performed while the vehicle 1 is traveling, for example. Note that, in FIG. 6, the items including the ignition switch 50, the status of the high-order control unit 20, the CAN reception of the high-order control unit 20, and the CAN transmission of the high-order control unit 20 are the same as those in FIG. 4.

As illustrated in FIG. 6, at a point in time T17 during the initialization state, the high-order control unit 20 acquires information indicating the actual state of the relay that is an example of the actual state information. The actual state of the relay at the point in time T17 is the ON state that differs from the OFF state, which is the initial value. Because the information indicating the actual state of the relay does not indicate the initial value, the high-order control unit 20 sets the ON state, which is the actual state of the relay at the point in time T17, as the control value for the system main relay. Thus, at the point in time T17, the management state of the relay is switched from the OFF state to the ON state. From the point in time T17 onward, the management state of the relay is maintained in the ON state.

In this case, when it is recognized that the ignition is switched on at the point in time T3 in the normal state, the management state of the relay is in the ON state. That is, at the point in time T3, the management state of the relay and the actual state of the relay are in the same control state. This makes it possible to avoid occurrence of erroneous detection of an adhesion abnormality in the system main relay and erroneous detection of an overvoltage of the motor even when the vehicle 1 is traveling at the point in time T3. Note that the embodiment, in which the value of the actual state information is set as the control value for the control target 24 when the actual state information does not indicate the initial value of the control value for the control target 24 in the initialization state, is not limited to the case where the vehicle 1 is traveling, but may be performed while the vehicle 1 is stopped.

Further, when the actual state information acquired in the initialization state does not indicate the initial value of the control value for the control target 24, the high-order control unit 20 may determine whether a predetermined exclusion condition is satisfied. The predetermined exclusion condition is whether it is determined that an abnormality has occurred or may possibly occur in the device mounted on the vehicle 1. Upon determining that the predetermined exclusion condition is satisfied, the high-order control unit 20 may set the initial value as the control value for the control target 24. In contrast, upon determining that the predetermined exclusion condition is not satisfied, the high-order control unit 20 may set the actual state information as the control value for the control target 24.

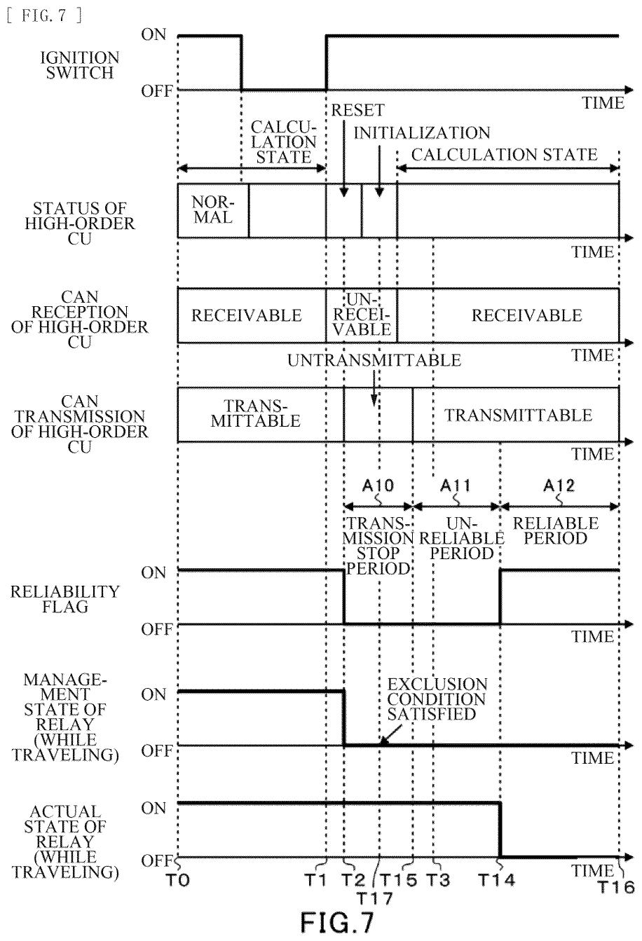

FIG. 7 is a time chart for describing an example of a case where it is determined that the predetermined exclusion condition is satisfied. Note that, in FIG. 7, the items including the ignition switch 50, the status of the high-order control unit 20, the CAN reception of the high-order control unit 20, and the CAN transmission of the high-order control unit 20 are the same as those in FIG. 6.

As illustrated in FIG. 7, at the point in time T17 during the initialization state, the high-order control unit 20 acquires the actual state information in the ON state that differs from the initial value. However, assume that occurrence of an abnormality has been detected in any of the devices mounted on the vehicle 1 at the point in time T17. In this case, at the point in time T17, the high-order control unit 20 determines that the exclusion condition is satisfied and sets the OFF state, which is the initial value, as the control value for the system main relay. That is, from the point in time T17 onward, the management state of the relay is maintained in the OFF state.

In this case, because the management state of the relay is in the OFF state at the point in time T14 when the reliability flag is brought into the ON state, the low-order control unit 22 switches the system main relay from the ON state to the OFF state, based on the instruction information in the OFF state. That is, at the point in time T14, the actual state of the relay is switched from the ON state to the OFF state. This makes it possible to appropriately stop the vehicle 1 and improve the safety of the vehicle 1 even when an abnormality occurs in an in-vehicle device. Note that the embodiment, in which the initial value is set as the control value for the control target 24 when it is determined that the exclusion condition is satisfied, is not limited to the case where the vehicle 1 is traveling, but may be performed while the vehicle 1 is stopped.

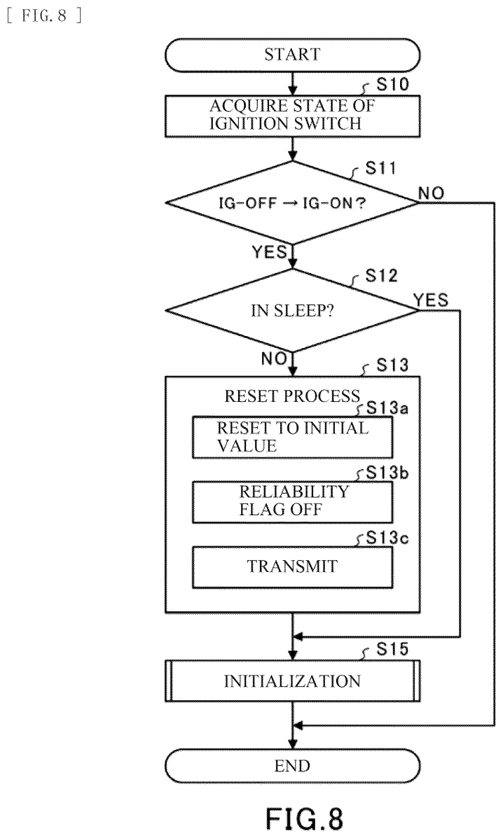

FIG. 8 is a flowchart for describing a flow of operation related to the reset process in the high-order controller 36. The high-order controller 36 repeatedly executes the series of processes illustrated in FIG. 8 at every predetermined interrupt timing that comes at a predetermined time interval.

When the predetermined interrupt timing comes, the high-order controller 36 acquires the information indicating the state of the ignition switch 50 (S10). The high-order controller determines whether the state of the ignition switch 50 has been switched from the OFF state (IG-OFF) to the ON state (IG-ON) (S11). For example, when the ignition switch 50 is in the OFF state at a previous interrupt timing and the ignition switch 50 is in the ON state at a current interrupt timing, it is determined that the ignition switch 50 has been switched from the OFF state to the ON state.

When it is determined that the ignition switch 50 has not been switched from the OFF state to the ON state (NO in S11), the high-order controller 36 ends the series of processes illustrated in FIG. 8.

When it is determined that the ignition switch 50 has been switched from the OFF state to the ON state (YES in S11), the high-order controller 36 determines whether the processor 32 is in sleep (S12).

When the processor 32 is not in sleep (NO in S12), the high-order controller 36 performs the reset process of resetting the control value for the control target 24 to the initial value (S13).

In the reset process, the high-order controller 36 resets the control value for the control target 24 to the initial value (S13a) and generates the instruction information in which the initial value is set as the control value for the control target 24. In the reset process, the high-order controller 36 sets the reliability flag to the OFF state (S13b). In the reset process, the high-order controller 36 transmits, to the low-order control unit 22, the instruction information in which the initial value is set as the control value for the control target 24 and the reliability flag in the OFF state (S13c). Note that, in the reset process, after the transmission of the instruction information and the transmission of the reliability flag, the high-order control unit 20 is brought into a state of being unable to perform transmission.

After the reset process, the high-order controller 36 performs initialization (S15) and ends the series of processes illustrated in FIG. 8.

When the processor 32 is in sleep (YES in S12), the high-order controller 36 performs initialization (S15), and ends the series of processes illustrated in FIG. 8. In this case, the reset process is not performed.

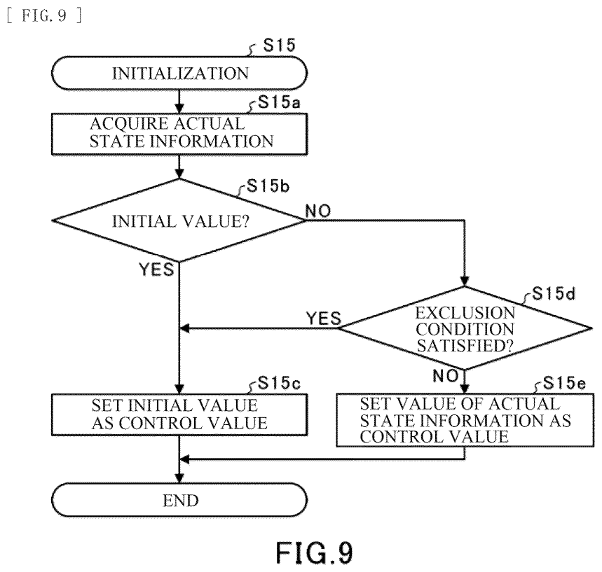

FIG. 9 is a flowchart for describing a flow of the initialization. Note that, in FIG. 9, only the process related to the present embodiment will be described, and the description of the process with low relevance to the present embodiment will be omitted.

When the initialization is started, the high-order controller 36 acquires the actual state information of the control target 24 (S15a). For example, the high-order controller 36 acquires the actual state information of the control target 24 by the various sensors 52 such as a voltage sensor and a current sensor.

Thereafter, the high-order controller 36 determines whether the acquired actual state information indicates the initial value (S15b).

When it is determined that the actual state information indicates the initial value (YES in S15b), the high-order controller 36 sets the initial value as the control value for the control target 24 (S15c), and ends the initialization.

Further, when it is determined that the actual state information does not indicate the initial value (NO in S15b), the high-order controller 36 determines whether the predetermined exclusion condition is satisfied. For example, when it is determined that an abnormality has occurred or may possibly occur in any of the devices mounted on the vehicle 1, the high-order controller 36 may determine that the exclusion condition is satisfied.

Upon determining that the predetermined exclusion condition is satisfied (YES in S15d), the high-order controller 36 sets the initial value as the control value for the control target 24 (S15c), and ends the initialization.

When it is determined that the predetermined exclusion condition is not satisfied (NO in S15d), the high-order controller 36 sets the value of the actual state information acquired in step S15a as the control value for the control target 24 (S15e), and ends the initialization.

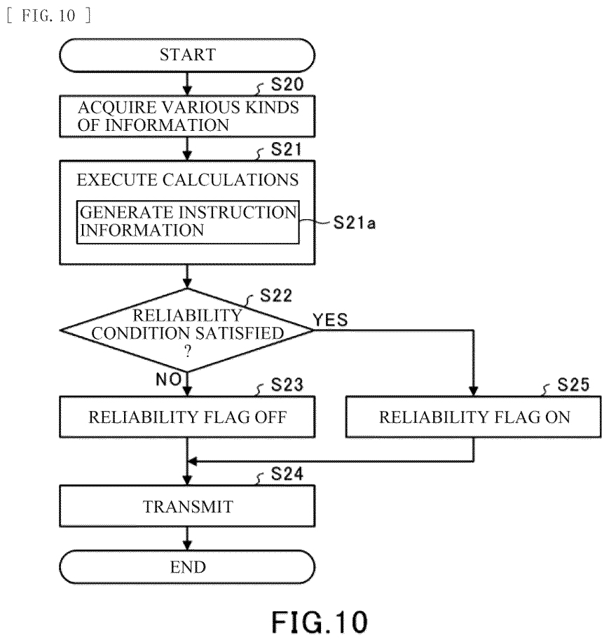

FIG. 10 is a flowchart for describing a flow of operation of the high-order controller 36 after completion of the initialization. After the completion of the initialization, the high-order controller 36 repeatedly executes the series of processes illustrated in FIG. 10 at every predetermined interrupt timing that comes at a predetermined time interval.

First, the high-order controller 36 acquires various kinds of information to be used for calculation from, for example, the sensors 52 of the vehicle 1 (S20). The high-order controller 36 executes various calculations (S21) including a process (S21a) of generating the instruction information for the control target 24, based on the acquired various kinds of information.

Thereafter, the high-order controller 36 determines whether the predetermined reliability condition is satisfied (S22). The reliability condition is, for example, that the rotation speed of the traveling motor is substantially zero.

If the reliability condition is not satisfied (NO in S22), the high-order controller 36 sets the reliability flag to the OFF state (S23). Thereafter, the high-order controller 36 transmits the generated instruction information and the reliability flag set to the OFF state to the low-order control unit 22 through the communicator 30 (S24), and ends the series of processes illustrated in FIG. 10.

When the reliability condition is satisfied (YES in S22), the high-order controller 36 sets the reliability flag to the ON state (S25). Thereafter, the high-order controller 36 transmits the generated instruction information and the reliability flag set to the ON state to the low-order control unit 22 through the communicator 30 (S24), and ends the series of processes illustrated in FIG. 10.

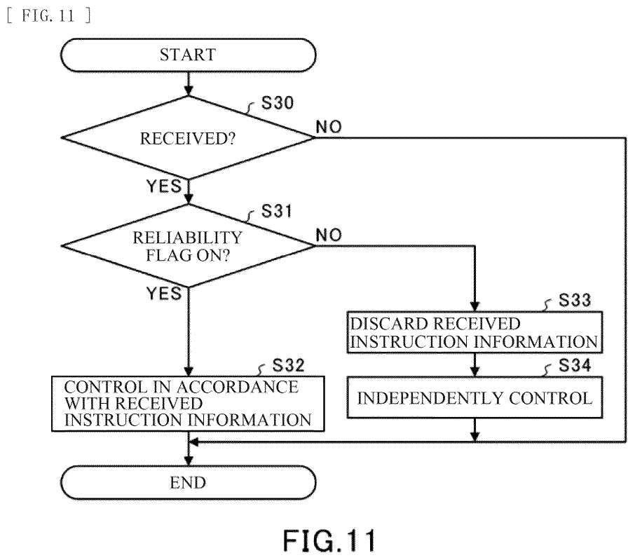

FIG. 11 is a flowchart for describing an outline of a flow of operation of the low-order controller 46. The low-order controller 46 repeatedly executes the series of processes illustrated in FIG. 11 at every predetermined interrupt timing that comes at a predetermined time interval.

When the predetermined interrupt timing comes, the low-order controller 46 determines whether the instruction information and the reliability flag have been received through the communicator 40 (S30). When the instruction information and the reliability flag have not been received (NO in S30), the low-order controller 46 ends the series of processes illustrated in FIG. 11.

When the instruction information and the reliability flag have been received (YES in S30), the low-order controller 46 determines whether the received reliability flag is in the ON state (S31).

When the received reliability flag is in the ON state (YES in S31), the low-order controller 46 executes the control of the control target 24 corresponding to the low-order controller 46 in accordance with the received instruction information, and ends the series of processes illustrated in FIG. 11.

When the received reliability flag is in the OFF state (NO in S31), the low-order controller 46 discards the received instruction information (S33), independently executes the control of the control target 24 corresponding to the low-order controller 46 (S34), and ends the series of processes illustrated in FIG. 11. Hereinafter, a specific flow of the operation of the low-order controller 46 will be described based on the flow of FIG. 11.

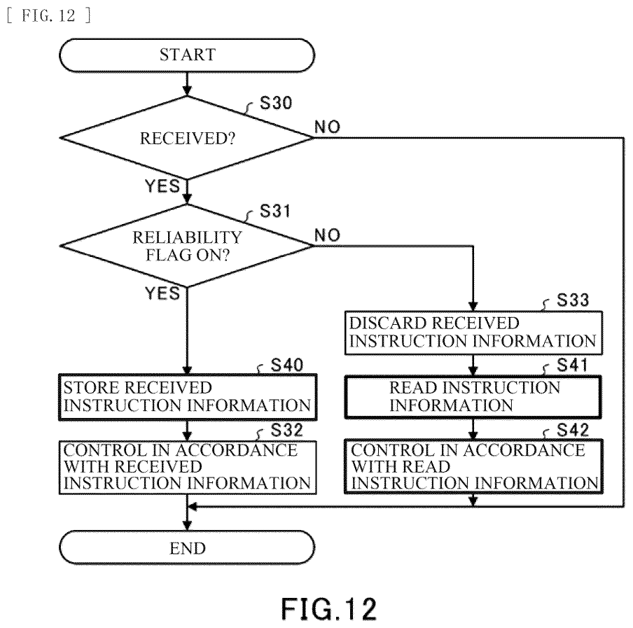

FIG. 12 is a flowchart for describing a first specific example of the operation of the low-order controller 46. Processes surrounded by thick frames in FIG. 12 are different from the processes in FIG. 11, and other processes are the same as those in FIG. 11. Thus, the processes in FIG. 12 different from those of FIG. 11 will be described, and descriptions for the same processes as those of FIG. 11 will be omitted.

As illustrated in FIG. 12, when the reliability flag is in the ON state (YES in S31), the low-order controller 46 temporarily stores the received instruction information in the memory 44 (S40). Thus, in the memory 44, the instruction information is updated every time the instruction information is received. Thereafter, the low-order controller 46 executes the control of the control target 24 in accordance with the received instruction information (S32).

Further, as illustrated in FIG. 12, when the reliability flag is in the OFF state (NO in S31), the low-order controller 46 discards the received instruction information (S33). Thereafter, the low-order controller 46 reads the instruction information stored in the memory 44 (S41) and executes the control of the control target 24 in accordance with the read instruction information (S42).

The memory stores the instruction information received when the reliability flag is in the ON state. Thus, in the first specific example, it is possible to execute the control of the control target 24 in accordance with the reliable instruction information and appropriately control the control target 24.

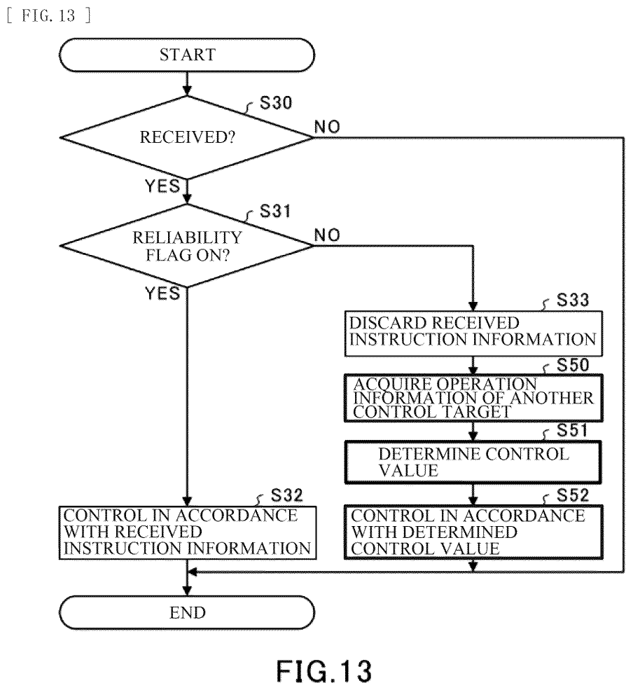

FIG. 13 is a flowchart for describing a second specific example of the operation of the low-order controller 46. Processes surrounded by thick frames in FIG. 13 are different from the processes in FIG. 11, and other processes are the same as those in FIG. 11. Thus, the processes in FIG. 13 different from those of FIG. 11 will be described, and descriptions for the same processes as those of FIG. 11 will be omitted.

Here, one low-order control unit 22 of interest among the multiple low-order control units 22 may be referred to as a predetermined low-order control unit 22. Further, another low-order control unit 22 that is other than the predetermined low-order control unit 22 among the multiple low-order control units 22 may be referred to as the other low-order control unit 22. Further, the control target 24 corresponding to the predetermined low-order control unit 22 may be referred to as a predetermined control target 24. Further, the control target 24 corresponding to the other low-order control unit 22 may be referred to as another control target 24. In the second specific example, the flow of the operation of the low-order controller 46 of the predetermined low-order control unit 22 will be described.

As illustrated in FIG. 13, when the reliability flag is in the OFF state (NO in S31), the low-order controller 46 discards the received instruction information (S33). Thereafter, the low-order controller 46 communicates with the other low-order control unit 22 through the communicator 40, and acquires operation information of the other control target 24 that is the control target 24 corresponding to the other low-order control unit 22 (S50). For example, when the other control target 24 is a traveling motor and an inverter, the operation information includes, for example, the rotation speed of the motor. Note that the operation state to be acquired is not limited to the rotation speed of the motor, and may be any parameter that allows the state of the vehicle 1 to be recognizable. The parameter includes, for example, the torque of the motor, the speed of the vehicle 1, and the accelerator position.

Thereafter, the low-order controller 46 determines the control value for the predetermined control target 24, based on the acquired operation information of the other control target 24 (S51). For example, when the acquired motor rotation speed is a value that is not substantially zero, the low-order controller 46 determines that the control value for the system main relay, which is an example of the predetermined control target 24, is to be the ON state. Thereafter, the low-order controller 46 executes the control of the predetermined control target 24 in accordance with the determined control value (S52). Thus, for example, the system main relay is controlled to be in the ON state.

In the second specific example, because the control of the predetermined control target 24 is executed based on the operation information of the other control target 24, it is possible to control the predetermined control target 24 with an appropriate control value in accordance with a current state of the vehicle 1.

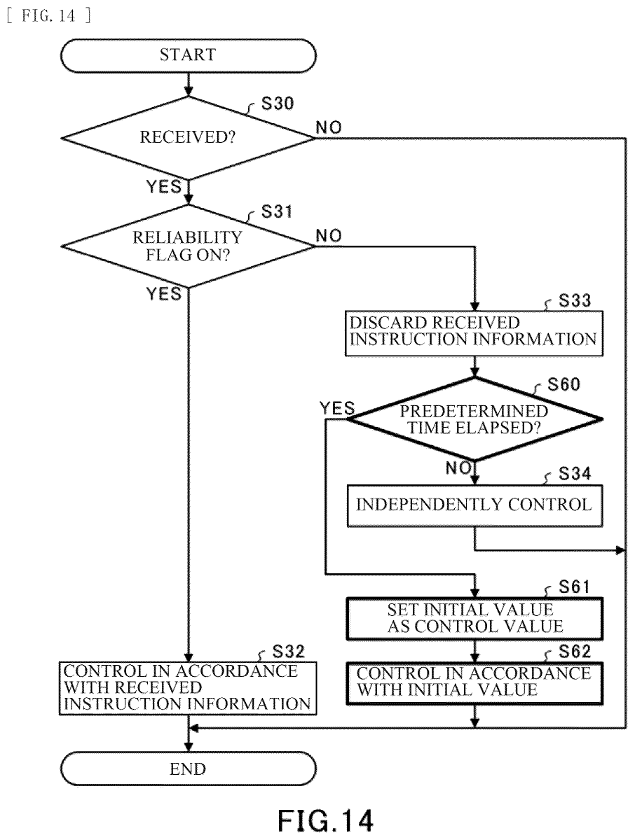

FIG. 14 is a flowchart illustrating a third specific example of the operation of the low-order controller 46. Processes surrounded by thick frames in FIG. 14 are different from the processes in FIG. 11, and other processes are the same as those in FIG. 11. Thus, the processes in FIG. 14 different from those of FIG. 11 will be described, and descriptions for the same processes as those of FIG. 11 will be omitted.

As illustrated in FIG. 14, when the reliability flag is in the OFF state (NO in S31), the low-order controller 46 discards the received instruction information (S33). Thereafter, the low-order controller 46 determines whether a predetermined period has elapsed from when the reliability flag is brought into the OFF state (S60). In other words, the low-order controller 46 determines whether a period in which the reliability flag in the OFF state indicating that the instruction information is unreliable is received exceeds the predetermined period.

When the predetermined time has not elapsed from when the reliability flag is brought into the OFF state, in other words, when the period during which the reliability flag in the OFF state is received is within the predetermined period (NO in S60), the low-order controller 46 executes the control of the control target 24 independently (S34).

When the predetermined time has elapsed from when the reliability flag is brought into the OFF state, in other words, when the period during which the reliability flag in the OFF state is received exceeds the predetermined period (YES in S60), the low-order controller 46 sets the initial value as the control value for the control target 24 (S61). For example, the low-order controller 46 sets the OFF state, which is the initial value, as the control value for the system main relay, which is the control target 24. Thereafter, the low-order controller 46 executes the control of the control target 24 in accordance with the set initial value (S62). Thus, for example, the system main relay is controlled to be in the OFF state.

In a situation where the period in which the reliability flag is received exceeds the predetermined period, there is a possibility that the high-order controller 36 has been unable to return to an appropriate state in which it is possible to generate the reliable instruction information. Thus, in the third specific example, it is possible to improve the safety of the vehicle 1 by controlling the control target 24 in accordance with the initial value in such a situation. For example, as described above, when the system main relay is controlled to be in the OFF state, which is the initial value, it is possible to reduce the occurrence of an abnormality in a device such as a high-voltage device of the vehicle 1.

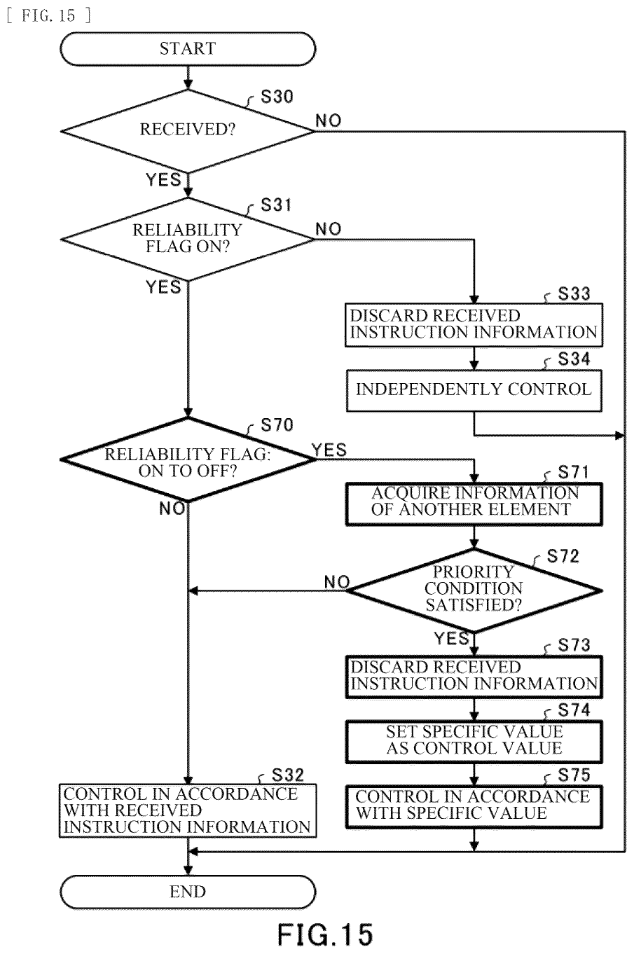

FIG. 15 is a flowchart illustrating a fourth specific example of the operation of the low-order controller 46. Processes surrounded by thick frames in FIG. 12 are different from the processes in FIG. 11, and other processes are the same as those in FIG. 11. Thus, the processes in FIG. 15 different from those of FIG. 11 will be described, and descriptions for the same processes as those of FIG. 11 will be omitted.

As illustrated in FIG. 15, when the reliability flag is in the ON state (YES in S31), it is determined whether the state has shifted from a state in which the reliability flag in the OFF state has been received to a state in which the reliability flag in the ON state is received (S70). For example, when the reliability flag in the OFF state is received at the previous interrupt timing and the reliability flag in the ON state is received at the current interrupt timing, the low-order controller 46 determines that the reliability flag has shifted from the OFF state to the ON state.

When the reliability flag in the ON state is continuously received (NO in S70), the low-order controller 46 executes the control of the control target 24 in accordance with the received instruction information.

When the state has shifted from the state in which the reliability flag in the OFF state has been received to the state in which the reliability flag in the ON state is received (YES in S70), the low-order controller 46 acquires the information of another element illustrated below (S71).

The other element includes any device other than the predetermined control target 24 corresponding to the predetermined low-order control unit 22 among the devices mounted on the vehicle 1. For example, the other element may be a traveling motor or a high-voltage battery. The information of the other element to be acquired is information on which it is possible to determine the protection and the safety of the device mounted on the vehicle 1. For example, the information of the other element to be acquired may be a rotation speed of the motor, a temperature of the battery, or a voltage or a current of each device.

Thereafter, the low-order controller 46 determines whether a predetermined priority condition related to protection of the device mounted on the vehicle 1 is satisfied based on the acquired information of the other element (S72). The predetermined priority condition is a condition for giving priority to the safety of the operation of the in-vehicle device over the instruction information received by the low-order control unit 22. More specifically, the predetermined priority condition is a condition including that the acquired information of the other element exceeds an appropriate range. For example, the low-order controller 46 may determine that the priority condition is satisfied when the acquired voltage or the acquired current of each device exceeds the appropriate range.

When it is determined that the predetermined priority condition is not satisfied (NO in S72), the low-order controller 46 executes the control of the control target 24 in accordance with the received instruction information because it is considered that there is no abnormality in each device (S32).

When it is determined that the predetermined priority condition is satisfied (YES in S72), the low-order controller 46 discards the received instruction information (S73), and sets a specific value that is set in advance in association with the priority condition as the control value for the control target 24 (S74). For example, when the specific value of the system main relay is set as the OFF state, the low-order controller 46 sets the OFF state as the control value for the system main relay, which is the control target 24. Note that the specific value may be the same as or different from the initial value. Thereafter, the low-order controller 46 executes the control of the control target 24 in accordance with the set specific value (S75). Thus, for example, the system main relay is controlled to be in the OFF state.

In the fourth specific example, the specific value is set as the control target 24 when the predetermined priority condition related to the protection of the device is satisfied. For example, according to the fourth specific example, in a situation where the voltage or the current of each device indicates an abnormal value when the ignition switch 50 is switched from the OFF state to the ON state, the system main relay is controlled to protect each device such as the system main relay being brought into the OFF state. Thus, in the fourth specific example, it is possible to appropriately protect each device of the vehicle 1.

As described above, in the control system 10 for the vehicle 1 of the present embodiment, the first processor performs generation of the instruction information indicating the control value for the control target. The first processor performs the reset process of resetting the control value for the control target 24 to the initial value when the specific condition is satisfied in the calculation state in which various calculations including the generation of the instruction information are executable. The first processor returns to the calculation state after the reset process. The first processor generates the reliability flag indicating the reliability of the instruction information. The first processor transmits the generated instruction information and the generated reliability flag to the second control unit. The second processor executes the control of the control target 24, based on the received instruction information and the received reliability flag.

Thus, the control system 10 for the vehicle 1 of the present embodiment makes it possible for the second processor to determine a control policy of the control target 24 in accordance with the state of the reliability flag. As a result, the control system 10 for the vehicle 1 of the present embodiment makes it possible to suppress spreading of an unintended influence caused by the reset process to the second control unit even when the reset process is performed in the first control unit.

Accordingly, the control system 10 for the vehicle 1 of the present embodiment makes it possible to reduce the occurrence of an abnormality in the vehicle 1 even when the reset process is performed in the control unit.

For example, in the control system 10 for the vehicle 1 of the present embodiment, it is possible to maintain the system main relay in the ON state as illustrated in the actual state of the relay in FIG. 4 until the reliability of the instruction information is restored even when the reset process is performed. As a result, the control system 10 for the vehicle 1 of the present embodiment makes it possible to reduce the occurrence of an abnormality such as adhesion in the system main relay.

Further, in the control system 10 for the vehicle 1 of the present embodiment, the second processor executes the control of the control target 24 in accordance with the received instruction information when the received reliability flag indicates that the instruction information is reliable. The second processor independently determines the control value for the control target 24 regardless of the received instruction information, and executes the control of the control target 24 in accordance with the determined control value when the received reliability flag indicates that the instruction information is unreliable.

Thus, the control system 10 for the vehicle 1 of the present embodiment makes it possible to appropriately reduce the occurrence of an abnormality in the vehicle 1 even when the reset process is performed in the control unit.

Further, in the control system 10 for the vehicle 1 of the present embodiment, the second processor executes the control of the control target 24 in accordance with the received instruction information, and stores the received instruction information in the second memory when the received reliability flag indicates that the instruction information is reliable. The second processor reads the instruction information stored in the second memory regardless of the received instruction information, and executes the control of the control target 24 in accordance with the read instruction information, when the received reliability flag indicates that the instruction information is unreliable.

Thus, the control system 10 for the vehicle 1 of the present embodiment makes it possible to more appropriately reduce the occurrence of an abnormality in the vehicle 1 even when the reset process is performed in the control unit.

Further, in the control system 10 for the vehicle 1 of the present embodiment, the second processor of a predetermined second control unit executes the control of the control target 24 in accordance with the received instruction information when the received reliability flag indicates that the instruction information is reliable. The second processor of the predetermined second control unit acquires the operation information of the other control target 24 that is the control target 24 corresponding to another second control unit that is other than the predetermined second control unit regardless of the received instruction information, when the received reliability flag indicates that the instruction information is unreliable. The second processor of the predetermined second control unit determines the control value for the control target 24 corresponding to the predetermined second control unit, based on the acquired operation information of the other control target 24, and executes the control of the control target 24 corresponding to the predetermined second control unit in accordance with the determined control value.

Thus, the control system 10 for the vehicle 1 of the present embodiment makes it possible to more appropriately reduce the occurrence of an abnormality in the vehicle 1 even when the reset process is performed in the control unit.

Further, in the control system 10 for the vehicle 1 of the present embodiment, the second processor sets the initial value as the control value for the control target 24, and executes the control of the control target in accordance with the set initial value regardless of the received instruction information, when the period in which the reliability flag indicating that the instruction information is unreliable is received exceeds the predetermined period.

Thus, the control system 10 for the vehicle 1 of the present embodiment makes it possible to improve the safety of the vehicle 1 by controlling the control target 24 to the initial value even in a situation where the first control unit has been unable to return to the appropriate state.

Further, in the control system 10 for the vehicle 1 of the present embodiment, when the predetermined priority condition related to protection of the device mounted on the own vehicle is satisfied, the second processor sets the specific value set in advance in association with the priority condition as the control value for the control target 24, and executes the control of the control target 24 in accordance with the set specific value regardless of the received instruction information.

Thus, in the control system 10 for the vehicle 1 of the present embodiment, the control target 24 is controlled with the specific value, making it possible to suppress spreading of an unintended influence caused by performing the reset process to devices other than the control target 24.

Further, in the control system 10 for the vehicle 1 of the present embodiment, in the reset process, the first processor resets the control value for the control target 24 to the initial value, generates the reliability flag indicating that the instruction information is unreliable, and transmits, to the second control unit, the instruction information in which the initial value is set as the control value for the control target 24 and the generated reliability flag indicating that the instruction information is unreliable.

Thus, the control system 10 for the vehicle 1 of the present embodiment makes it possible to appropriately reduce the occurrence of an abnormality in the vehicle 1 even when the reset process is performed in the control unit.

Further, in the control system 10 for the vehicle 1 of the present embodiment, after the reset process, the first processor returns to the calculation state after executing initialization. The first processor, in the initialization, acquires the actual state information indicating the actual state of the control target 24. The first processor sets the value of the actual state information as the control value for the control target 24 when the actual state information does not indicate the initial value of the control value for the control target 24.

Thus, the control system 10 for the vehicle 1 of the present embodiment makes it possible to reduce a deviation between a result of the control performed by the second control unit and the control value for the control target 24 in the first control unit even when the second control unit independently controls the control target 24. As a result, the control system 10 for the vehicle 1 of the present embodiment makes it possible to avoid, for example, occurrence of erroneous detection of an adhesion abnormality of the system main relay or an overvoltage of the motor.

Further, in the control system 10 for the vehicle 1 of the present embodiment, the first processor, in the initialization, determines whether the predetermined exclusion condition is satisfied when the actual state information does not indicate the initial value of the control value for the control target 24. The first processor sets the initial value as the control value for the control target 24 upon determining that the exclusion condition is satisfied. The first processor sets the value of the actual state information as the control value for the control target 24 upon determining that the exclusion condition is not satisfied.

Thus, in the control system 10 for the vehicle 1 of the present embodiment, when the exclusion condition is satisfied, the initial value is forcibly set as the control value for the control target 24. This makes it possible to improve the safety of the vehicle 1 by setting, for example, the occurrence of an abnormality in the in-vehicle device as the exclusion condition.

Although embodiments of the invention have been described in the foregoing with reference to the accompanying drawings, the invention is by no means limited to such embodiments. It should be appreciated that various modifications and alterations may be made by persons skilled in the art without departing from the scope as defined by the appended claims. The invention is intended to include such modifications and alterations in the technical scope thereof.

For example, the specific examples illustrated in the above embodiments may be combined as appropriate.

Further, in the above-described embodiments, the high-order control unit 20 transmits the instruction information and the reliability flag indicating the reliability of the instruction information to the low-order control unit 22. However, the low-order control unit 22 may generate feedback information indicating a control result of the control target 24 and the reliability flag indicating the reliability of the feedback information, and transmit the generated feedback information and the generated reliability flag to the high-order control unit 20. Thereafter, the high-order control unit 20 may, for example, execute a calculation or perform correction of the calculation result, based on the received feedback information and the received reliability flag.

Further, it is possible for the present embodiment to provide programs for executing the processes of functions of the above-described units. Further, it is possible to provide a non-transitory computer-readable recording medium in which the programs are stored. The non-transitory recording medium may be, for example, a disk-type recording medium such as an optical disk, a magnetic disk, or a magneto-optical disk, or may be a semiconductor memory such as a flash memory or a USB memory.

### DESCRIPTION OF REFERENCE NUMERALS

1 Vehicle
20 High-order control unit
22 Low-order control unit
24 Control target
32 Processor
34 Memory
42 Processor
44 Memory

1. A vehicle control system comprising:
a first control unit comprising one or more first processors and one or more first memories coupled to the one or more first processors;
a second control unit comprising one or more second processors and one or more second memories coupled to the one or more second processors, the second control unit being configured to communicate with the first control unit; and
a control target associated with the second control unit, wherein
the one or more first processors are configured to execute a process comprising:
performing generation of instruction information indicating a control value for the control target;
performing a reset process of resetting the control value for the control target to an initial value when a specific condition is satisfied in a calculation state in which various calculations comprising the generation of the instruction information are executable;
returning to the calculation state after the reset process;
generating a reliability flag indicating reliability of the instruction information; and
transmitting the generated instruction information and the generated reliability flag to the second control unit, and
the one or more second processors are configured to execute a process comprising executing control of the control target, based on the received instruction information and the received reliability flag.

2. The vehicle control system according to claim 1, wherein the one or more second processors are configured to execute a process comprising:
executing the control of the control target in accordance with the received instruction information when the received reliability flag indicates that the instruction information is reliable; and
independently determining the control value for the control target regardless of the received instruction information, and executing the control of the control target in accordance with the determined control value, when the received reliability flag indicates that the instruction information is unreliable.

3. The vehicle control system according to claim 2, wherein the one or more second processors are configured to execute a process comprising:
executing the control of the control target in accordance with the received instruction information, and storing the received instruction information in the second memory, when the received reliability flag indicates that the instruction information is reliable; and
reading the instruction information stored in the second memory regardless of the received instruction information, and executing the control of the control target in accordance with the read instruction information, when the received reliability flag indicates that the instruction information is unreliable.

4. The vehicle control system according to claim 2, comprising second control units comprising the second control unit, wherein
the second control units are configured to communicate with each other,
the control target corresponding to the second control unit is different for each of the second control units,
one second control unit of interest among the second control units comprises a predetermined second control unit, and
the one or more second processors of the predetermined second control unit are configured to execute a process comprising:
executing the control of the control target in accordance with the received instruction information when the received reliability flag indicates that the instruction information is reliable;
acquiring operation information of another control target that is the control target corresponding to another second control unit that is other than the predetermined second control unit regardless of the received instruction information, when the received reliability flag indicates that the instruction information is unreliable; and
determining the control value for the control target corresponding to the predetermined second control unit, based on the acquired operation information of the other control target, and executing the control of the control target corresponding to the predetermined second control unit in accordance with the determined control value.

5. The vehicle control system according to claim 2, wherein the one or more second processors are configured to execute a process comprising setting the initial value as the control value for the control target, and executing the control of the control target in accordance with the set initial value regardless of the received instruction information, when a period in which the reliability flag indicating that the instruction information is unreliable is received exceeds a predetermined period.

6. The vehicle control system according to claim 2, wherein, when a predetermined priority condition related to protection of a device mounted on an own vehicle is satisfied, the one or more second processors are configured to execute a process comprising setting a specific value set in advance in association with the priority condition as the control value for the control target, and executing the control of the control target in accordance with the set specific value regardless of the received instruction information.

7. The vehicle control system according to claim 1, wherein the one or more first processors are configured to execute, in the reset process, a process comprising resetting the control value for the control target to the initial value, generating the reliability flag indicating that the instruction information is unreliable, and transmitting, to the second control unit, the instruction information in which the initial value is set as the control value for the control target and the generated reliability flag indicating that the instruction information is unreliable.

8. The vehicle control system according to claim 1, wherein
the one or more first processors are configured to execute a process comprising, after the reset process, returning to the calculation state after executing initialization, and
the one or more first processors are configured to execute, in the initialization, a process comprising:
acquiring actual state information indicating an actual state of the control target; and
setting a value of the actual state information as the control value for the control target when the actual state information does not indicate the initial value of the control value for the control target.

9. The vehicle control system according to claim 8, wherein the one or more first processors are configured to execute, in the initialization, a process comprising:
determining whether a predetermined exclusion condition is satisfied when the actual state information does not indicate the initial value of the control value for the control target;
setting the initial value as the control value for the control target upon determining that the exclusion condition is satisfied; and
setting the value of the actual state information as the control value for the control target upon determining that the exclusion condition is not satisfied.
